(19) United States
(12) Patent Application Publication
(10) Pub. No.: US 2016/0193685 A1
(43) Pub. Date: Jul. 7, 2016

(54) METHOD FOR PRODUCING A WELDED JOINT

(71) Applicant: MAGNA STEYR FAHRZEUGTECHNIK AG & CO KG, Graz (AT)

(72) Inventors: Werner KARNER, Graz (AT); Helmut TREVEN, Gössendorf (AT)

(73) Assignee: MAGNA STEYR Fahrzeugtechnik AG & Co KG, Graz (AT)

(21) Appl. No.: 14/910,796

(22) PCT Filed: Aug. 5, 2014
(86) PCT No.: PCT/EP2014/066829

§ 371 Date: Feb. 8, 2016

(30) Foreign Application Priority Data
Aug. 6, 2013 (EP) 13179352.3

(51) Int. Cl. B23K 9/23

(52) U.S. Cl. CPC B23K 9/232; B23K 2203/20

(57) ABSTRACT

A method for producing a welded joint between a steel sheet and an aluminum sheet, wherein the steel sheet and the aluminum sheet are clamped horizontally and are welded together on only one side in the welding position, a corresponding welded joint and a component comprising a corresponding welded joint.

### CROSS-REFERENCE TO RELATED APPLICATIONS

The present application is a National Stage Application of PCT International Application No. PCT/EP2014/066829 (filed on Aug. 5, 2014), under 35 U.S.C. §371, which claims priority to European Patent Application No. 13179352.2 (filed on Aug. 6, 2013), which are each hereby incorporated by reference in their respective entireties.

### TECHNICAL FIELD

Embodiments relates to a method for producing a welded joint between a steel sheet and an aluminum sheet, to a welded joint thereby produced, and to a component comprising a welded joint of this kind.

### BACKGROUND

Methods for producing a welded joint between a steel sheet and an aluminum sheet are already known. In particular, it is known that a steel sheet and an aluminum sheet can be welded via the Cold Metal Transfer (CMT) process developed by the Fronius Company. For this purpose, the steel sheet and the aluminum sheet are set up vertically and welded upright and in a downward direction from both sides in position PG via respective welding sets. The end face of the steel sheet must be coated with zinc during welding, and, after trimming in the welding region, it is therefore necessary for previously zinc-coated steel sheets to be subsequently re-coated with zinc at this point before welding.

FIGS. 1a through 1c illustrate steps of a prior art method for producing a welded joint between a steel sheet 1 and an aluminum sheet 2.

As illustrated in FIG. 1a, in this method, the two sheets 1, 2 are set up vertically. The steel sheet is zinc-coated all-round, i.e., both on the surface 3 of the steel sheet 1 and on the end face of the steel sheet 1, the end face being shown as pointed here and having been re-coated with zinc after a trimming operation.

As illustrated in FIG. 1b, a welding machine, represented as a welding torch 8, is used on both sides of the future weld seam, and welding is performed simultaneously by both welding torches 8 in the welding position PG.

As illustrated in FIG. 1c, a hybrid plate comprising steel and aluminum with a welding bead 11 on both sides is formed.

### SUMMARY

Embodiments relate to a method for producing a welded joint between a steel sheet and an aluminum sheet which is simple and low-cost and, at the same time, produces a strong welded joint.

Embodiments relate to an improved welded joint between a steel sheet and an aluminum sheet and to indicate a component comprising an improved welded joint.

In accordance with embodiments, a method for producing a welded joint between a steel sheet and an aluminum sheet using a welding torch, and includes at least one of: coating the steel sheet on an upper side and a lower side thereof in a region of the weld; clamping the steel sheet and the aluminum sheet horizontally; welding the steel sheet and the aluminum sheet together on only one side in a welding position PA, thereby forming a welding bead on the upper side and the lower side of the steel sheet and the aluminum sheet, with the result that the steel sheet and the aluminum sheet join together on the side facing the welding torch and on the side facing away from the welding torch.

In accordance with embodiments, therefore, the steel sheet and the aluminum sheet are welded together only from one side. This results in a requirement of only a single welding torch, and thus, only a single current path during welding. For a welded joint of good quality, this is made possible by the fact that the sheets are arranged and fixed in position horizontally, i.e., lying flat, the steel sheet is coated, in particular zinc-coated, on the upper side and lower side thereof, and the aluminum sheet and steel sheet are welded in the welding position PA, i.e., horizontally. During the welding or braze welding process, the aluminum sheet melts at the joint over the entire thickness of the aluminum sheet, as does additionally, where applicable, a welding wire or welding filler. This melt or these two melts forms or form the primary molten material, which causes the coating, e.g., a zinc layer on the steel sheet, to melt only slightly at the surface. The molten aluminum, the welding wire or filler and the coating (zinc layer) melted at the surface combine and form a material joint. The melted material of the aluminum sheet and of the welding wire or welding filler trickles down right through the joint and combines with the coating on the lower side of the steel-sheet component. A zinc layer on the steel sheet melts at about 400 degrees Celsius, and the aluminum sheet melts at about 600 degrees Celsius, for example. Since the zinc layer is melted only at the surface during welding, “quick welding” is possible. A welding bead is formed on both sides, wherein the welding bead is formed to a large extent of melted aluminum and the melted welding wire or welding filler.

Developments of the invention are indicated in the dependent claims, the description and the attached drawings.

In accordance with embodiments, the steel sheet and the aluminum sheet are preferably welded together by an MIG process, in particular by a cold metal transfer (CMT) process or Advanced CMT process. Embodiments, therefore, are not restricted to welding methods involving direct current but can also be carried out via welding methods which employ alternating current or pulsating direct current, for example.

As a preferred option, the steel sheet and the aluminum sheet are positioned to form a butt joint when clamping.

In accordance with embodiments, the steel sheet is welded to the aluminum sheet at a steel end face, wherein the steel sheet has a coating, in particular a zinc layer or aluminum layer, on the steel end face. In this case, a fused joint between the aluminum melt and the coating is formed at the end of the aluminum sheet and, where applicable, of the welding wire.

The end face of the steel is preferably uncoated. In this case, the molten material is applied only to the end face of the steel, and therefore welding at the end face takes place only in this broader sense. In this case, expensive subsequent milling and zinc-coating of the steel sheet can be omitted.

For the purpose of clamping, the steel sheet and the aluminum sheet are preferably placed on blocks, in particular on metal blocks. The blocks preferably have a spacing of 5-50 mm, preferably 8-20 mm, particularly preferably 8-10 mm, in the region of the weld seam.

For the purpose of clamping, the steel sheet and the aluminum sheet are preferably pressed down on the upper side thereof via a clamping device.

As a particularly preferred option, the clamping device is designed in such a way that it comprises clamping elements which have a minimum spacing of 2-40 mm, preferably 5-12 mm, particularly preferably 5-7 mm, even more preferably about 6 mm, in the region of the weld seam.

It is particularly advantageous if the spacing of the clamping elements increases in an upward direction in the region of the weld seam, i.e., the end faces of the clamping elements taper toward the sheets. Better access for a welding torch is thereby obtained.

A welding torch preferably slopes relative to the perpendicular to the aluminum sheet during welding, in particular at an angle of 0.5-10 degrees to the perpendicular, preferably of about 2-5 degrees to the perpendicular.

In a preferred embodiment, the steel sheet and the aluminum sheet are welded together in trimming regions, wherein the trimming regions have cutting burrs on one side, wherein the cutting burrs point in opposite directions during the welding process. In particular, the trimming regions can be formed by trimming the metal sheets via guillotine shears.

As a particularly preferred option, the cutting burr of the steel sheet points upward during the welding process i.e. toward the welding torch.

Embodiments relate to a welded joint between a steel sheet and an aluminum sheet, wherein the welded joint is produced by a method in accordance with embodiments.

Embodiments relate to a component comprising a steel sheet and an aluminum sheet, wherein the steel sheet and the aluminum sheet are joined together by a welded joint in accordance with embodiments.

### DRAWINGS

Embodiments will be explained below in closer detail by reference to the drawings, in which:

FIGS. 1 a through 1c illustrate steps of a prior art method for producing a welded joint.

FIGS. 2a through 2c illustrate steps of a method for producing a welded joint, in accordance with embodiments.

FIG. 3 illustrates a detailed schematic view of the method step of FIG. 2.

FIG. 4 illustrates a schematic view of trimming regions of the sheets with cutting burrs on one side, in accordance with embodiments.

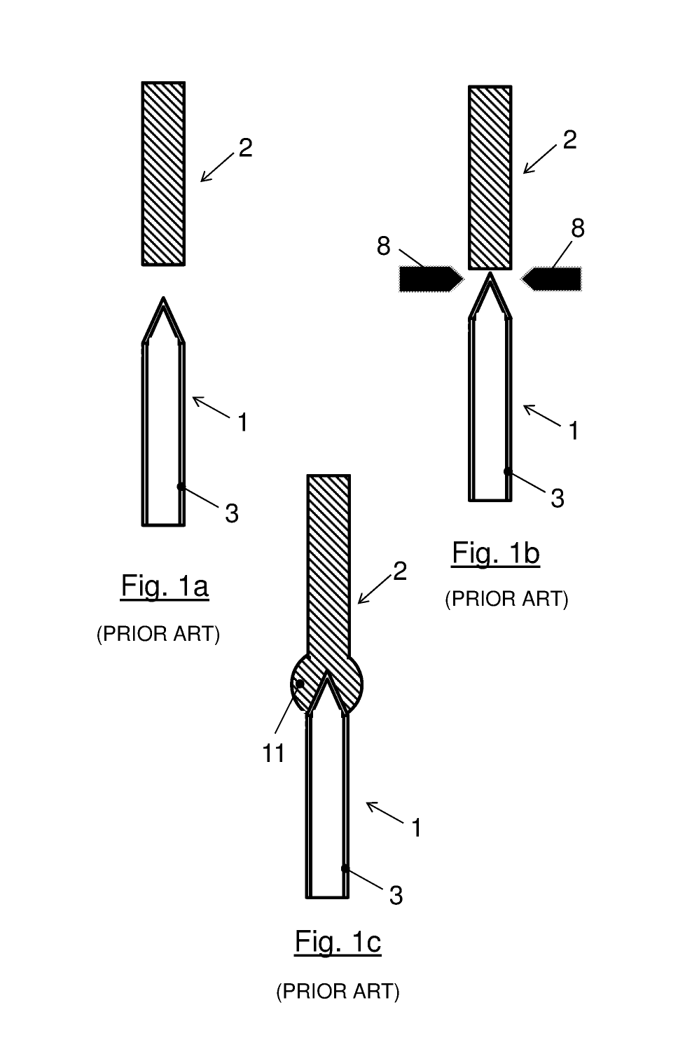

### DESCRIPTION

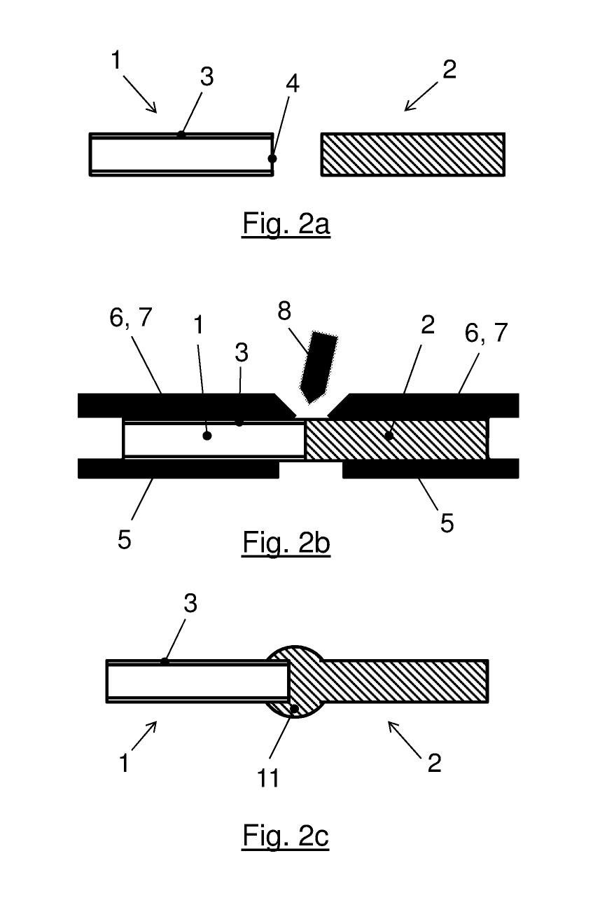

In accordance with embodiments, the method for producing a welded joint between a steel sheet 1 and an aluminum sheet 2, e.g., Al₅ₓₓₓ or Al₆ₓₓₓ, is illustrated in FIGS. 2a through 2c. The steel sheet 1 is welded to the aluminum sheet 2 at a steel end face 4 which does not have a zinc layer since trimming to size has been performed with guillotine shears, for example. In contrast, the surface 3 of the steel sheet 1 is zinc-coated, as far as possible free from scratches in the region of the weld seam and cleaned with precision cleaner. The aluminum sheet 2 is brushed and degreased and likewise cleaned with precision cleaner.

As illustrated in FIG. 2b, the steel sheet 1 and the aluminum sheet 2 are clamped horizontally and welded together on only one side via a welding torch 8 in the welding position PA by a CMT process. Both sheets 1, 2, are placed on metal blocks 5, which are arranged spaced apart. On the upper side, the sheets 1, 2, are pressed down via a clamping device 6. The clamping device 6 comprises clamping elements 7 which rest and press on the two sheets 1, 2, over an extended area. In the region of the future weld seam, these clamping elements 7 have a spacing, thus allowing the welding torch 8 to be applied.

As illustrated in FIG. 2c, the welding gives rise to a welding bead 11 on both sides since the steel/aluminum hybrid plate is welded right through despite the unilateral torch configuration. During this process, the aluminum has been converted to a molten state, while the steel has not been. The zinc has been used as a flux.

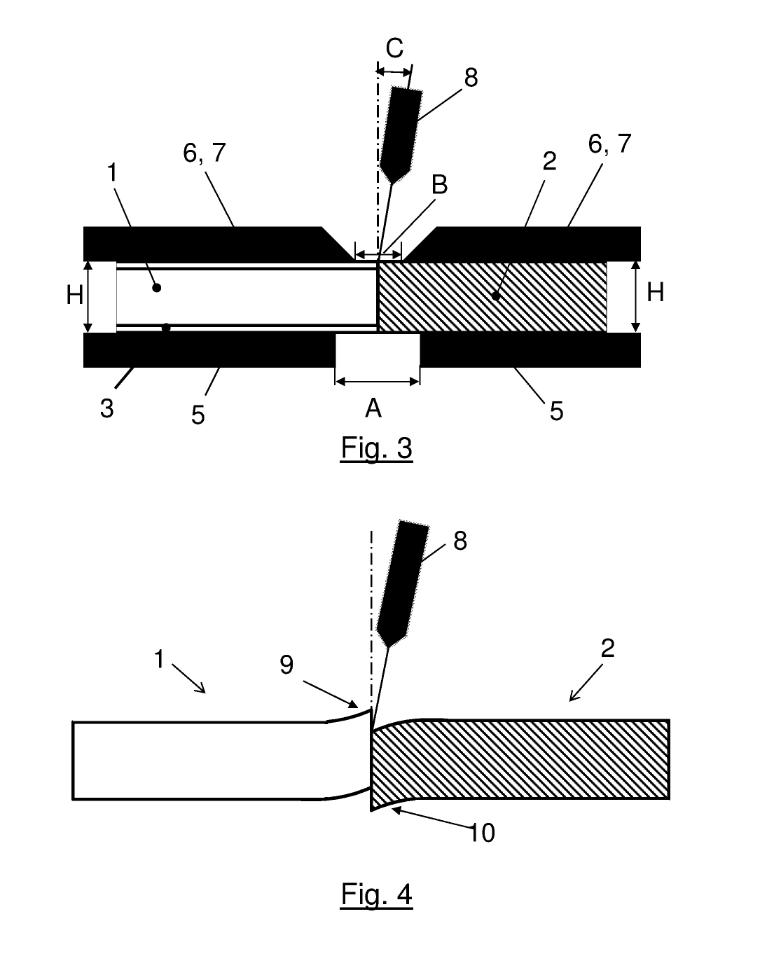

As illustrated in FIG. 3, a detailed schematic view of a welding process in accordance with embodiments. In the region of the weld seam, the metal blocks 5 have a spacing A of 8-10 mm. The clamping elements 7 on the upper side of the sheets 1, 2, have a spacing B of at least 6 mm, which increases upward. The welding torch 8 uses the shielding gas argon 4.6-5.0 and, in the welding position PA with a butt joint, is used with a feed rate of 0.3-1 m/min. Welding is performed at 10-15 degrees using a push technique. The welding torch 8 is tilted at an angle C of about 2-5 degrees to the perpendicular to the aluminum sheet 2. The height H, both in the case of the aluminum sheet 2 and the steel sheet 1, including the zinc layer on the surface 3 thereof, is about 0.8-4 mm, preferably 1.5-2 mm. In accordance with embodiments, Z100/100-Z350/350 or ZE50/50-ZE100/100 is used for the zinc layer, for example. The following can be used as welding fillers, for example, depending on the aluminum involved: AlMg_{4.5}MnZr for Al₅ₓₓₓ and AlSi₃Mn₁ for Al₆ₓₓₓ.

Aluminized steel sheets have a thin aluminum layer, in the region of 60 μm, for example. The abovementioned welding fillers can also be used.

As illustrated in FIG. 4, a schematic view of the trimming regions of the sheets 1, 2, with cutting burrs 9, 10 on one side, these having formed during cutting with guillotine shears. The cutting burrs 9, 10 point in opposite directions during welding. The cutting burr 9 on steel sheet 1 points upward toward the welding torch 8.

The term “coupled” or “connected” may be used herein to refer to any type of relationship, direct or indirect, between the components in question, and may apply to electrical, mechanical, fluid, optical, electromagnetic, electromechanical or other connections. In addition, the terms “first,” “second, etc. are used herein only to facilitate discussion, and carry no particular temporal or chronological significance unless otherwise indicated.

This written description uses examples to disclose the invention, including the preferred embodiments, and also to enable any person skilled in the art to practice the invention, including making and using any devices or systems and performing any incorporated methods. The patentable scope of embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, may be mixed and matched by one of ordinary skill in the art to construct additional embodiments and techniques in accordance with principles of this application.

### LIST OF REFERENCE SIGNS

1 steel sheet
2 aluminum sheet
3 surface of the steel sheet
4 steel end face
5 block
6 clamping device
7 clamping element
8 welding torch
9 cutting burr of the steel sheet
10 cutting burr of the aluminum sheet
11 welding bead
A spacing of the blocks
B spacing of the clamping elements
C angle of the welding torch to the perpendicular
H height

1-15. (canceled)

16. A method for producing a welded joint between a steel sheet and an aluminum sheet using a welding torch, the method comprising:
coating the steel sheet, at an upper side and a lower side thereof, in a weld region;
horizontally clamping the steel sheet and the aluminum sheet; and
forming a welding bead on the upper side and the lower side of the steel sheet and the aluminum sheet by welding the steel sheet and the aluminum sheet together on only one side in a welding position, wherein the steel sheet and the aluminum sheet are joined together on a side facing the welding torch and on a side facing away from the welding torch.

17. The method of claim 16, wherein forming the welding bead comprises welding the steel sheet and the aluminum sheet together by a CMT process or an advanced CMT process.

18. The method of claim 16, wherein the horizontally clamping comprises positioning the steel sheet and the aluminum sheet to form a butt joint when clamping.

19. The method of claim 16, wherein coating the steel sheet comprises coating a zinc coating or an aluminized coating on the upper side and the lower side of the steel sheet.

20. The method of claim 16, wherein forming the welding bead comprises welding the steel sheet and the aluminum sheet together at an end face of the steel sheet.

21. The method of claim 20, wherein the end face of the steel sheet has a coating.

22. The method of claim 21, wherein the coating on the end face comprises a zinc coating or an aluminum coating.

23. The method of claim 16, wherein the horizontally clamping comprises placing the steel sheet and the aluminum sheet on blocks.

24. The method of claim 23, wherein the blocks have a spacing of 8-10 mm in a region of the weld seam.

25. The method of claim 16, wherein the horizontally clamping comprises pressing the steel sheet and the aluminum sheet down on respective upper sides thereof via a clamping device.

26. The method of claim 25, wherein the clamping device comprises clamping elements that are spaced apart 6 mm in a region of the weld seam.

27. The method of claim 25, wherein the spacing of the clamping elements increases in an upward direction in the region of the weld seam.

28. The method of claim 16, wherein forming the welding bead comprises sloping the welding torch at a predetermined angle relative to the perpendicular of the steel sheet during welding.

29. The method of claim 16, wherein the predetermined angle is about 2-5 degrees.

30. The method of claim 16, wherein forming the welding bead comprises welding the steel sheet and the aluminum sheet together in trimming regions thereof, the trimming regions having cutting burrs on one side.

31. The method of claim 31, wherein the cutting burrs point in opposite directions during the welding process.

32. The method of claim 31, wherein the cutting burrs of the steel sheet points upward during the welding process.

33. A welded joint between a steel sheet and an aluminum sheet, wherein the welded joint is produced by:
coating the steel sheet, at an upper side and a lower side thereof, in a weld region;
horizontally clamping the steel sheet and the aluminum sheet; and
forming a welding bead on the upper side and the lower side of the steel sheet and the aluminum sheet by welding the steel sheet and the aluminum sheet together on only one side in a welding position, wherein the steel sheet and the aluminum sheet are joined together on a side facing a welding torch and on a side facing away from the welding torch.

34. A component comprising a steel sheet and an aluminum sheet, wherein the steel sheet and the aluminum sheet are joined together by a welded joint produced by:
coating the steel sheet, at an upper side and a lower side thereof, in a weld region;
horizontally clamping the steel sheet and the aluminum sheet; and
forming a welding bead on the upper side and the lower side of the steel sheet and the aluminum sheet by welding the steel sheet and the aluminum sheet together on only one side in a welding position, wherein the steel sheet and the aluminum sheet are joined together on a side facing a welding torch and on a side facing away from the welding torch.
